(19) United States
(12) Patent Application Publication
(10) Pub. No.: US 2002/0035518 A1
(43) Pub. Date: Mar. 21, 2002

(54) Method and system and computer program product for providing commodity information

(76) Inventor: Makoto Kano, Inagi-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/953,865

(22) Filed: Sep. 18, 2001

(30) Foreign Application Priority Data
Sep. 19, 2000 (JP) 2000-283907

(51) Int. Cl. G06F 17/60

(52) U.S. Cl. 705/26

(57) ABSTRACT

In a method of providing commodity information to a commodity information requester via a network, a selection of commodity is received from the requester via the network, a item or item which are associated with a commodity selected by the requester is selected from items of personal information that have been collected in advance, requester specific commodity information is generated based on commodity information on the selected commodity and the selected item or items of the personal information, and the requester specific commodity information is provided to the requester.

### CROSS-REFERENCE TO RELATED APPLICATIONS

This application is based upon and claims the benefit of priority from the prior Japanese Patent Application No. 2000-283907, filed Sep. 19, 2000, the entire contents of which are incorporated herein by reference.

### BACKGROUND OF THE INVENTION

1. Field of the Invention

The present invention relates to a commodity information providing method and system for providing commodity information and a computer program product, in the case where shopping is carried out via a network such as Internet, for example.

2. Description of the Related Art

A conventional shopping system connected to Internet provides commodity information to a commodity information requester. In the case where a commodity is an electrical product, commodity information containing information on functions or performance of such a product is provided to the requester.

In the case where a commodity is an air conditioner, information concerning power consumption, size, or various functions and information concerning an approximate area for a room suitable to such a product are provided to the requester.

However, even if the area for such room is the same, the capability required for an air conditioner differs depending on conditions such as a place of residence, a room layout, an occupying rate of materials placed in room, a heat insulation effect of the room, or a setup position of air conditioner.

Thus, it is difficult to find an air conditioner having its capability suitable to the requester's utilization environment by utilizing the conventional shopping system over Internet.

In addition, in the case where a commodity is clothes, even if the same size is displayed, the size may differ depending on manufacturer. For example, although one manufacturer's shirt just fits the requester in size, another manufacturer's shirt may be short in sleeve even if the size is the same as that of such one manufacturer's shirt.

In shopping over Internet, one cannot try to wear one's desired item, thus making it difficult to find a commodity of its size that just fits the requester.

Thus, in shopping over Internet, although commodity information is provided to the requester, there is a problem that it is difficult to evaluate/judge whether or not a commodity is suitable to the requester's utilization environment (conditions).

In the “commodity information providing apparatus and method” disclosed in Japanese Patent Application KOKAI Publication No. 10-207941, there is described the apparatus and method for, in the case of selling or purchasing clothes or accessories and the like, carrying out simulation that assumes a scene in which such clothes or accessories are actually used. In addition, this apparatus and method provides an actual use scene and commodity information and displays an image produced by composing a commodity and a background picture or display of an image produced by combining a plurality of commodities such as shirt and tie.

However, what the requesters really wants to know is whether or not such commodity is suitable to the requester oneself, and the invention of Japanese Patent Application KOKAI Publication No. 10-207941 does not solve this problem.

As has been described above, in shopping over Internet, although commodity information is provided, there is a problem that the requester cannot know whether or not such commodity is suitable to the requester's utilization environment.

### BRIEF SUMMARY OF THE INVENTION

The present invention has been made in view of the foregoing circumstance. It is an object of the present invention to provide a commodity information providing method and system and a computer program product capable of evaluating whether or not a desired commodity is suitable to oneself in the case where one purchases such commodity via a network.

According to a first aspect of the present invention, there is provided a method of providing commodity information to a commodity information requester via a network, comprising:

receiving a commodity selection instruction from the requester via the network;

selecting an item or items which are associated with the commodity selected by the requester from among items of personal information of the requester that have been collected in advance;

generating requester specific commodity information based on commodity information on the selected commodity and the selected item or items of the personal information; and

providing the generated requester specific commodity information to the requester.

The personal information includes at least one of body information, economic information, living information, property information or the like.

By utilizing the first aspect of the invention, simulation is carried out as to whether or not such commodity is suitable to the requester's utilization environment based on an item or items which are associated with the commodity selected by the requester from among items of the requester's personal information and commodity information on the commodity (simulation model), and the result can be provided to the requester.

Therefore, in the case of purchasing a commodity via a network, such commodity can be purchases after commodity evaluation in one's utilization environment has been carried out based on one's personal information.

According to the first aspect of the invention, change request information may be received from a requester to the requester specific commodity information, the requester specific commodity information may be changed based on the change request information, and the changed requester specific commodity information may be provided to the requester.

In this case, when the requester evaluates the result of simulation, and instructs a simulation after changing various specifications such as commodity size or color, simulation is carried out again in consideration of such change, and the result after changed is obtained.

For example, in the case where the commodity size is not proper, the requester instructs a commodity size change, and instructs simulation again, thereby making it possible to easily and speedily find a commodity of its suitable size.

According to a second aspect of the present invention, there is provided a method of providing commodity information to a commodity information requester via a network,

generating requester specific commodity information indicating a commodity or commodities related to the requester based on personal information of the requester that has been collected in advance; and

providing the requester specific commodity information to the requester via the network.

E-mail may be utilized as a technique for providing the requester specific commodity information indicating the commodity related to the requester. In addition, in order to generate the requester specific commodity information on a commodity suitable to the requester, simulation may be carried out based on the personal information.

By utilizing the second aspect of the invention, a commodity fitting the requester, a commodity estimated to be required by the requester, or a commodity whose size or performance is judged to be suitable to the requester by way of simulation is automatically selected based on the requester's personal information. Then, commodity information on this selected recommended commodity is notified to the requester as the requester specific commodity information via E-mail, for example.

In this manner, a chance in which commodity information on a desired commodity to be purchased by a requester is provided to the requester can be increased, and a chance for the requester to make contact with a commodity seller can be increased.

According to the first and second aspects of the invention, the personal information may be recorded in a recording medium held by the requester, and may be utilized after read out from this recording medium.

On the other hand, the personal information may be recorded in a recording medium owned by the commodity information provider, and may be utilized after read out from this recording medium.

In addition, according to the first and second aspects of the invention, authentication may be carried out using user identification information, whereby only the requester's personal information may be utilized. In this manner, the safety of personal information is ensured.

In addition, according to the first and second aspects of the invention, the decision of purchase of the commodity may be received from the requester. In this manner, commodity selling via a network can be carried out for a requester who has provided commodity information.

In the case where the decision of purchase of a commodity has been received, the personal information may be updated based on the decision of purchase of the commodity. In this manner, for example, a newly purchased commodity can be added as property information of personal information, and rich contents of personal information can be achieved.

According to a third embodiment of the present invention, there is provided a commodity information providing system for providing commodity information to a commodity information requester, the system comprising:

an input section that inputs an instruction for selecting a commodity from the requester;

a personal information selecting section that selects an item or items which are associated with the commodity selected by the requester from among items of personal information of the requester that have been collected in advance;

a simulation section that generates requester specific commodity information based on commodity information on the commodity indicated by a selection instruction inputted by the input section and the selected item or items of the personal information; and

an output section that outputs to the requester the requester specific commodity information generated by the simulation section.

According to the third aspect of the invention, the input section may input from the requester, change request information relevant to the requester specific commodity information generated by the simulation section, the simulation section may change the requester specific commodity information based on the change request information, and the output section may output to the requester the changed requester specific commodity information.

According to a fourth aspect of the present invention, there is provided a commodity information providing system for providing commodity information to a commodity information request, the system comprising:

a commodity information selection section that generates requester specific commodity information indicating a commodity or commodities related to the requester based on personal information of the requester that has been collected in advance; and

an output section that outputs to the requester the requester specific commodity information.

According to the third and fourth aspects of the invention, there may be provided an authentication section that carries out authentication by using user identification information, and reads out only the requester's personal information.

In addition, according to the third and fourth aspects of the invention, the input section may input an instruction for deciding to purchase the commodity selected from the requester, and may comprise a purchase processing section that executes commodity purchase processing based on the instruction for deciding to purchase the commodity inputted by the input section. In addition, there may be provided an update section that updates the personal information based on the purchase decision instruction.

The above third and fourth aspects of the invention and their modified example are directed to a commodity information providing system for achieving the commodity information providing method according to the first and second aspects of the invention and their modified example.

By utilizing the third and fourth aspects of the invention and their modified example, advantageous effect similar to those according to the first and second aspects of the invention and their modified example can be achieved.

According to a fifth aspect of the present invention, there is provided an article of manufacture comprising a computer usable medium having computer readable program code means embodied therein, the computer program code means comprising:

a receipt computer readable program code means for causing a computer to receive an instruction for selecting a commodity from the requester;

a personal information selection computer readable program code means for causing the computer to select an item or items which are associated with the commodity selected by the requester from among items of personal information of the requester that have been collected in advance;

a simulation computer readable program code means for causing the computer to generate requester specific commodity information based on commodity information on the selected commodity and the selected item or items of the personal information; and

a provision computer readable program code means for causing the computer to provide the requester specific commodity information to the requester.

According to the fifth aspect of the invention, the receipt code may receive change request information relevant to the requester specific commodity information; the simulation code may change the requester specific commodity information based on the change request information; and the provision code may provide the changed requester specific commodity information to the requester.

According to a sixth aspect of the present invention, an article of manufacture comprising a computer usable medium having computer readable program code means embodied therein, the computer program code means comprising:

a commodity information selection computer readable program code means for causing a computer to generate requester specific commodity information indicating a commodity or commodities related to the requester based on personal information of the requester that has been collected in advance; and

a provision computer readable program code means for causing the computer to provide the requester specific commodity information to the requester.

According to the fifth and a sixth aspect of the present invention, there may be provided an authentication code that carries out authentication by using user identification information, and reads out only the requester's personal information.

In addition, according to the fifth and sixth aspects of the invention, the receipt code may receive from the requester an instruction for deciding to purchase the commodity, and may comprise a purchase processing code that executes commodity purchase processing based on the purchase decision instruction. In addition, an update code that updates the personal information based on the purchase decision instruction may be provided.

By using such a program product, a function for carrying out the first and second aspects of the invention and their modified example can be easily added to a computer, computer system, client, or server that does not have a function for carrying out the first and second aspects of the invention and their modified example.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiment of the invention, and together with the general description given above and the detailed description of the embodiment given below, serve to explain the principles of the invention.

FIG. 1 is a block diagram illustrating a configuration of a commodity information providing system according to a first embodiment of the present invention;

FIG. 2 is a data structure chart showing a specific example of personal information;

FIG. 3 is a flow chart illustrating procedures for operating a work station and an HTTP server provided in a commodity information providing system according to the present embodiment;

FIG. 4 is a flow chart illustrating a requester's operation procedures according to the present embodiment;

FIG. 5 is a block diagram illustrating a commodity information providing system according to a second embodiment of the present invention;

FIG. 6 is a block diagram illustrating a configuration of a commodity information providing system according to a third embodiment of the present invention;

FIG. 7 is a block diagram illustrating a configuration of a commodity information providing system according to a fourth embodiment of the present invention;

FIG. 8 is a flow chart illustrating procedures for operating a work station and an HTTP server provided in a commodity information providing system according to the present embodiment;

FIG. 9 is a block diagram illustrating a configuration of a commodity information providing system according to a fifth embodiment of the present invention;

FIG. 10 is a block diagram illustrating a configuration of a commodity information providing system according to a sixth embodiment of the present invention;

FIG. 11 is a flow chart illustrating procedures for operating a work station and an HTTP server provided in a commodity information providing system;

FIG. 12 is a block diagram illustrating a program product having recorded therein a commodity information providing program for achieving a function of a commodity information providing system on a computer;

FIG. 13 is a home page according to an eighth embodiment of the present invention;

FIG. 14 is a first simulation window according to the present embodiment;

FIG. 15 is a second simulation window according to the present embodiment;

FIG. 16 is a home page according to a ninth embodiment of the present invention;

FIG. 17 is a simulation window according to the present embodiment;

FIG. 18 is a view showing an example of a dialog box for user ID and password entry according to a tenth embodiment of the present invention;

FIG. 19 is a home page according to the present embodiment; and

FIG. 20 is a simulation window according to an eleventh embodiment of the present invention.

### DETAILED DESCRIPTION OF THE INVENTION

Hereinafter, preferred embodiments of the present invention will be described with reference to the accompanying drawings.

(First Embodiment of the Invention)

The present embodiment describes a commodity information providing system having personal information stored in a commodity information requester's device. The commodity information providing system is adopted to carrying out a commodity information providing method for executing simulation at the requester's device.

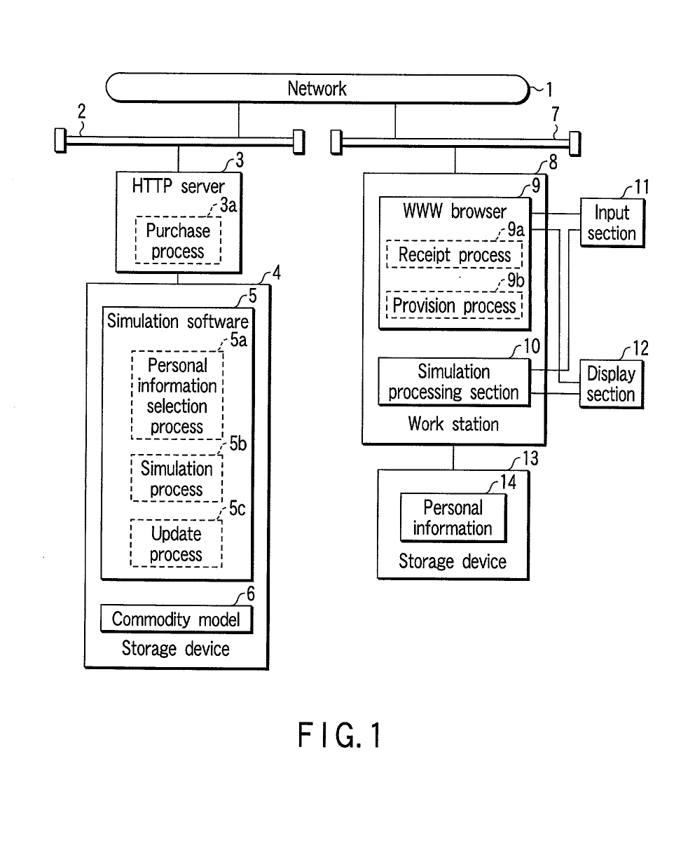

FIG. 1 is a block diagram illustrating a configuration of a commodity information providing system according to the present embodiment.

In the commodity information providing system, a work station 8 belonging to a LAN 7 and an HTTP server 3 belonging to a LAN 2 are connected to each other via a network 1.

The HTTP server 3 provides information on a variety of commodities to the work station 8 equipped with a WWW browser 9. This server 3 has simulation software 5 and a commodity model (commodity information) 6 stored in a storage device 4.

In addition, the HTTP server 3 executes a purchase process 3a in the case where the server has received information on commodity purchase.

The simulation software 5 is initiated on the work station 8. This software 5 executes a personal information selecting process 5a, a simulation process 5b, and an update process 5c.

Specifically, the simulation software 5 selects personal information associated with a commodity selected by a requester from among items of personal information 14 that have been collected in advance. For example, the commodity information and the items of personal information are associated with each other. Then, the simulation software 5 carries out commodity simulation based on set environmental conditions, the commodity model of the selected commodity, and personal information associated with the selected commodity, evaluates a function and performance of a commodity. The simulation software 5 updates personal information 14 if the commodity has been purchased.

A commodity model 6 includes a simulation model of a commodity required for processing of the simulation software 5 and a variety of information concerning the commodity.

In this way, the simulation software 5 and commodity model 6 are stored in the storage device 4 of the HTTP server 3, whereby a function for simulating a product can be provided to each Internet subscriber terminal, i.e., the work station 8 of the requester comprising the WWW browser 9.

The work station 8 is a device for requesting commodity information to the HTTP server 3. This work station comprises a simulation processing section 10, an input section 11, a display section (output section) 12, and a storage device 13 or the like.

The WWW browser 9 is software that receives a document or image file stored in the HTTP server 3, and encodes the contents of the file.

In addition, the WWW browser 9 executes a receiving process 9a for receiving an instruction from the requester and a providing process 9b for providing information to the requester.

The input section 11 inputs a command from the requester such as request for a home page, selection of commodity, start of simulation.

The display section 12 displays a home page or simulation result (including a request for specific commodity information).

The personal information 14 is stored in a storage device 13 of the work station 8.

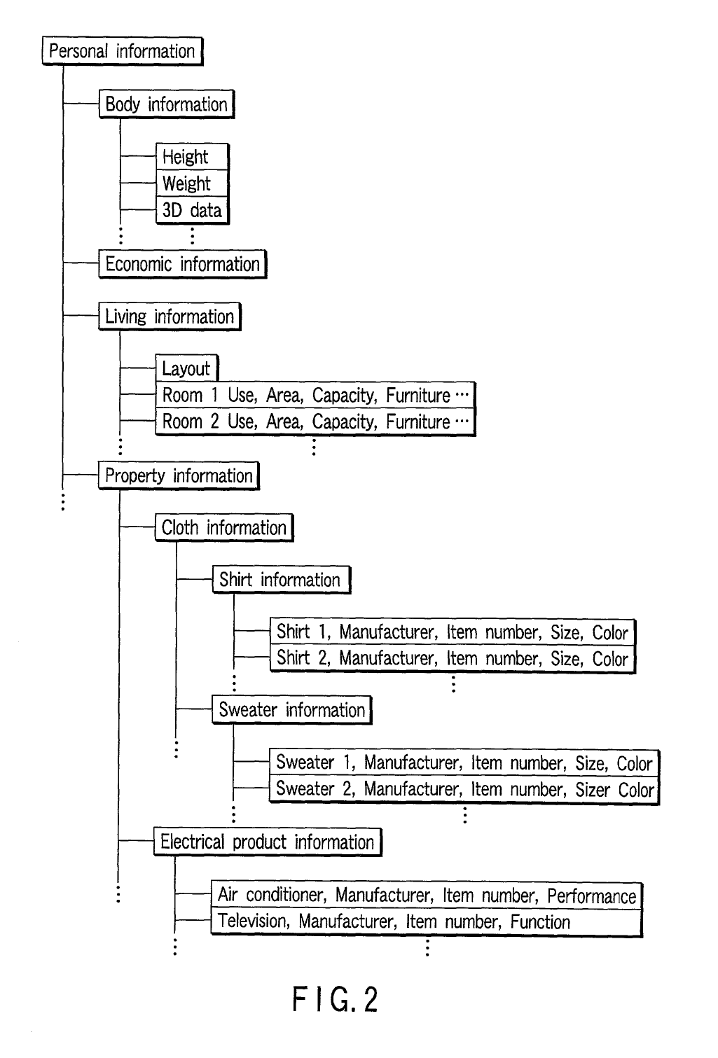

FIG. 2 is a data structure chart showing a specific example of the personal information 14.

The personal information 14 includes body information on the requester, economic information, living information, property information or the like. When simulation is executed, required information is utilized from among items of the personal information 14.

In addition, when the requester decides to purchase, the commodity to be purchased is added to property information included in items of the personal information 14, and the updated the personal information 14 are stored to be overwritten in the storage device 13 of the work station 8. Although not shown in FIG. 2, in the case where a commodity is selected by the requester, such selected commodity may be added to an item called selection information included in items of the personal information 14.

A commodity information providing method achieved by a commodity information providing system having the above configuration will be described here.

When the requester inputs an initiation command to the input section 11, the WWW browser 9 is initiated on the work station 8, and a home page is requested to the HTTP server 3.

The home page is transmitted from the HTTP server 3 to the work station 8.

When, when a commodity on the home page is selected by the requester, and the selection command is inputted to the input section 11, the selection contents are received by the WWW browser 9, and a simulation is requested to the HTTP server 3.

The simulation software 5 and commodity model 6 stored in the storage device 4 are transmitted from the HTTP server 3 to the work station 8. The simulation software 5 and commodity model 6 from the HTTP server 3 are set by the simulation processing section 10 of the work station 8, and are ready for a request for setting the personal information 14.

When a file name of the personal information 14 is inputted from the requester through the input section 11, the personal information 14 is read out from the corresponding file of the storage device 13, and the simulation software 5 received from the HTTP server 3 is initiated by the simulation processing section 10 of the work station 8.

Then, only personal information associated with the selected commodity is selected from among items of the personal information 14 read out from the storage device 13 of the work station 8 by the simulation software 5. Simulation is executed based on the selected personal information and the commodity model 6 received from the HTTP server 3. The simulation result is displayed by the display section 12.

Hereinafter, procedures for operating the work station 8 and HTTP server 3 will be described.

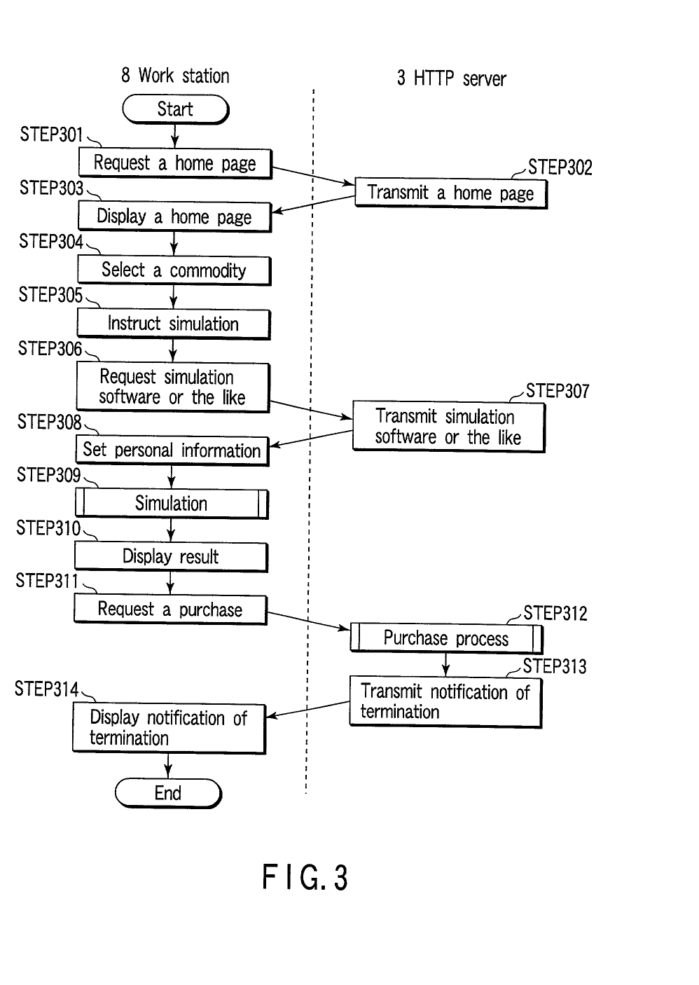

FIG. 3 is a flow chart illustrating procedures for operating the work station 8 and HTTP server 3 provided in the commodity information providing system according to the present embodiment.

Here, procedures from the purchase of one commodity to the end of the purchase are presented for describing transmission/receiving between the work station 8 and the HTTP server 3. However, in actuality, after the purchase procedures, a commodity is selected again on a home page, and commodities can be continuously purchased.

First, in response to making a request for a home page from the work station 8 (STEP 301), the home page is transmitted from the HTTP server 3 to the work station 8 (STEP 302).

The work station 8 displays this home page on the display section 12 (STEP 303), and then, waits for input.

A commodity is selected from among the home page by the requester (STEP 304), and simulation is instructed (STEP 305). Then, the work station 8 requests the HTTP server 3 for the simulation software 5 or commodity model 6 and the like (STEP 306).

In response to making a request from the work station 8, the simulation software 5 and the commodity model 6 of the selected commodity or the like are transmitted from the HTTP server 3 (STEP 307).

The work station 8 receives the simulation software 5, commodity model 6 or the like, and waits for personal information input.

When a file name of the personal information 14 is inputted, a file containing the personal information 14 stored in the storage device 13 is opened, the personal information 14 is read, and the personal information 14 is set (STEP 308).

When the personal information 14 is set, simulation is executed (STEP 309). In this simulation, personal information associated with the selected commodity is selected from among items of set personal information 14, a simulation process 5b is executed based on the selected personal information and the commodity model 6, and the simulation result is displayed on the display section 12 (STEP 310).

When purchasing is instructed by the requester, a purchase process 3a is requested from the work station 8 to the HTTP server 3 (STEP 311). In addition, a commodity to be purchased is added to property information included in items of the personal information 14, and the personal information 14 is stored to be overwritten in the storage device 13.

The HTTP server 3 executes the purchase process 3a in response to a purchase process request from the work station 8 (STEP 312). When the purchase process 3a terminates, the notification of termination is transmitted to the work station 8 (STEP 313), and the end of purchase procedures is displayed at the display section 12 of the work station 8 (STEP 314).

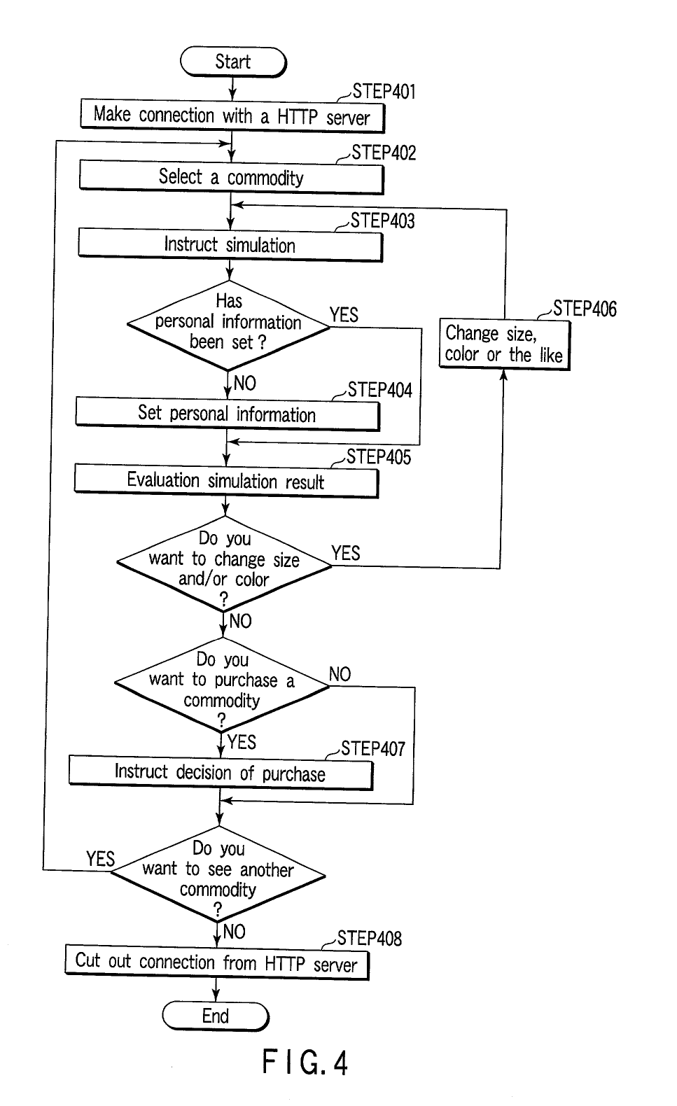

FIG. 4 is a flow chart illustrating the requester's operation procedures.

The requester first initiates the WWW browser 9 of the work station 8, accesses the HTTP server 3, and requests a home page (STEP 401).

Then, the home page is transmitted from the HTTP server 3, and the home page is displayed at the display section 12 of the work station 8.

Next, the requester selects one commodity from the home page displayed at the display section 12 of the work station 8 (STEP 402), and instructs simulation (STEP 403).

Then, it is checked whether or not the personal information 14 is set. If the personal information 14 is set, the work station 8 requests the HTTP server 3 for the simulation software 5 and commodity model 6 or the like. As a result, simulation is executed by the work station 8 based on the simulation software 514 transmitted from the HTTP server 3, commodity model 6, and personal information, and the simulation result is displayed at the display section 12.

On the other hand, if the personal information 14 is not set, the setting of the personal information 14 is requested. In this case, the requester inputs a file name of the personal information 14, and instructs reading from the file, whereby the personal information 14 is set (STEP 404). Then, simulation is executed by the work station 8, and the simulation result is displayed at the display section 12.

The requester evaluates the displayed simulation result (STEP 405). In the case where an attempt is made to change specifications of the commodity, such as the color, size, or the like of the commodity, the requester carried out change processing of the commodity size or color (STEP 406), and processing returns to STEP 403.

Then, in the case where the requester purchases a selected commodity, the requester instructs the purchase (STEP 407).

Then, the purchase process 3a is requested from the work station 8 to the HTTP server 3, the purchase process 3a is carried out by the HTTP server 3. In addition, a commodity to be purchased is added to the property information included in items of the personal information 14, and the personal information 14 is stored to be overwritten in the storage device 13 of the work station 8.

In the case where an attempt is made to see another commodity, processing returns to step 402. In the case of exiting processing, connection with the HTTP server 3 is cut out, and shopping is terminated (STEP 408).

Hereinafter, advantageous effect achieved by a commodity information providing system according to the present embodiment will be described.

As a first advantageous effect, in the commodity information providing system according to the present embodiment, simulation is executed based on the requester's personal information 14 that has been acquired in advance and the commodity model 6 of the commodity selected by this requester, and the requester specific commodity information is displayed.

Therefore, the requester can evaluate a commodity based on one's utilization environment, and can purchase only the commodity judged to be suitable to oneself.

As a second advantageous effect, in the commodity information providing system according to the present embodiment, after evaluation of the requester's simulation result, for example, specifications such as size or color are changed, and simulation can be executed again.

Therefore, the requester instructs a commodity size change in the case where the commodity size is not suitable as a result of simulation, for example, and instructs simulation again, and can find a commodity suitable to oneself easily and speedily.

As a third advantageous effect, in the commodity information providing system according to the present embodiment, the personal information 14 includes body information on the requester, economic information, living information, property information or the like. Part or all of the personal information 14 is utilized for simulation in accordance with the selected commodity.

Therefore, simulation can be carried out for every commodity in detail in consideration of the requester's utilization environment.

As a fourth advantageous effect, in the commodity information providing system according to the present embodiment, the personal information 14 is stored in the requester's storage device 13, thus making it easy to set the personal information 14.

As a fifth advantageous effect, in the commodity information providing system according to the present embodiment, even in the case where the requester carried out a plural times of simulations, as long as the personal information 14 is set once, there is no need to set the personal information 14 in the subsequent simulation. In particular, in the case of executing a plural times of simulations, even if different types of commodities are handled or type of personal information utilized for simulation must be changed, required personal information is automatically selected from the personal information 14.

Therefore, after the requester has set the personal information 14 once, procedures for setting the personal information 14 can then be eliminated, and operation burden can be reduced.

As a sixth advantageous effect, in the commodity information providing system according to the present embodiment, when the requester purchases a commodity, the personal information 14 on the requester is updated, and information on the purchased commodity, for example, is added to property information included in items of the personal information 14.

Therefore, the personal information 14 can be automatically updated, and the rich contents and management of the personal information 14 are easily achieved.

As a seventh advantageous effect, in the commodity information providing system according to the present embodiment, the simulation software 5 and commodity model 6 are downloaded from the provider's (commodity information provider's) HTTP server 3 to the requester's work station 8, and simulation is carried out at the requester's side.

Therefore, even in the case where simulation is carried out simultaneously if a plurality of requesters requires the same commodity, an amount of burden on computation by the provider's device can be restrained. In addition, for the requester, there is no need to transmit the personal information 14 to the provider's side, and the leakage of personal information 14 can be prevented.

As an eighth advantageous effect, in the commodity information providing system according to the present embodiment, if the simulation software 5 is downloaded from the provider's side to the requester's side once, there is no need to download the simulation software 5 every time. In particular, even in the case where the types of commodities are different from each other in a plurality of simulations, the available personal information and available commodity model 6 are different from each other, and common simulation software 5 is available.

In this way, even in the case where a plurality of commodities are evaluated by way of simulation, the simulation software 5 may be downloaded only once. Thus, the subsequent transmission of the simulation software 5 can be eliminated.

Other embodiments of the commodity information providing system according to the present invention will be described. The same portions as those of the first embodiment will be indicated in the same reference numerals and their detailed description will be omitted.

(Second Embodiment)

The present embodiment describes a commodity information providing system having personal information stored in a smart card, the system being adopted to carry out a commodity information providing method for executing simulation by the requester's device.

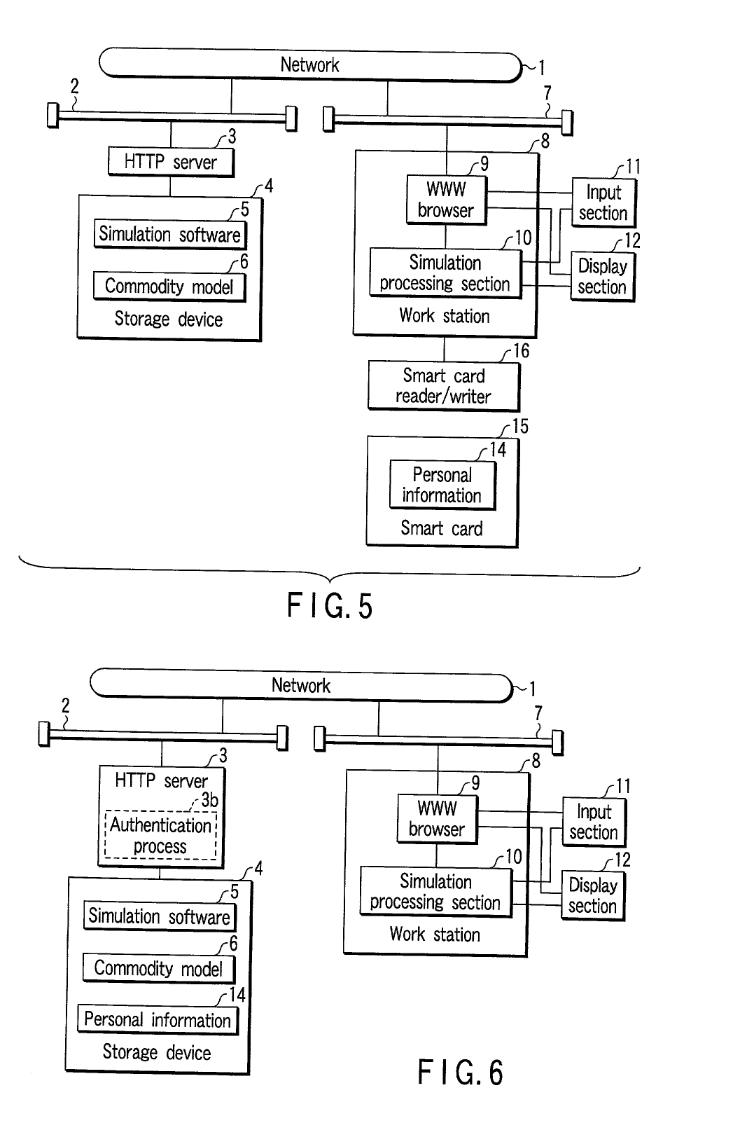

FIG. 5 is a block diagram illustrating a configuration of a commodity information providing system according to the present embodiment.

Although the personal information 14 is stored in the storage device 13 of the work station 8 in the first embodiment, the personal information 14 is stored in a smart card 15 in the second embodiment. In addition, the work station 8 is equipped with a smart card reader/writer 16.

The personal information 14 stored in the smart card 15 is read by the smart card reader/writer 16 equipped at the work station 8, and the personal information 14 is set.

In addition, when the requester decides to purchase a commodity, the commodity to be purchased is added to property information included in items of the personal information 14, and new personal information 14 is stored in the smart card 15 by means of the smart card reader/writer 16.

In the case where the personal information 14 may be stored in a mobile device such as a portable terminal or a portable telephone set instead of the smart card 15, the personal information 14 may be read out from such a mobile device, and a commodity is purchased, the updated personal information 14 may be written in this mobile device.

In the commodity information providing system according to the present embodiment as described above, in addition to advantageous effect similar to that according to the first embodiment, the personal information 14 can be held in the smart card 15 or mobile device.

Therefore, even in the case of shopping at the outside, the personal information 14 is read by a work station at the outside, whereby commodity evaluation due to simulation can be easily carried out.

(Third Embodiment)

The present embodiment describes a commodity information providing system having personal information stored in the provider's device, the system being adopted to carry out commodity information providing method for executing simulation by the requester s device.

FIG. 6 is a block diagram illustrating a configuration of the commodity information providing system according to the present embodiment.

Although the personal information 14 is stored in the storage device 13 of the work station 8 in the first embodiment, the personal information 14 is stored in the storage device 4 of the HTTP server 3 in the third embodiment. The other configuration is similar to that shown in FIG. 1. Thus, a description is omitted here.

A user ID and a password are stored in advance to be associated with the personal information 14 in the storage device 4 of the HTTP server 3.

When the user ID and password are transmitted from the work station 8 to the HTTP sever 3, the password associated with the user ID is compared with a received password by means of an authentication process 3b of the HTTP sever 3. When these passwords are coincident, the personal information 14 associated with the user ID is read out from the storage device 4, the read out information is transmitted to the work station 8, and new personal information 14 is set.

When the requester decides to purchase a commodity, the commodity to be purchased is added to property information included in items of the personal information 14 at the work station 8. Then, the personal information 14 is transmitted from the work station 8 to the HTTP server 3, and is stored to be overwritten in the storage device 4 of the HTTP server 3.

In the present embodiment, all of the personal information 14 may not be stored at the provider's side, wherein a part of the personal information 14 may be stored at the provider's side, and the other part may be stored at the requester's side.

In the commodity information providing system according to the present embodiment as described above, in addition to advantageous effect similar to that according to the first embodiment, the personal information 14 or a part of such information is stored at the provider's side as a data file or a part of the data file. The requester inputs a user ID that has been registered in advance, thereby specifying a person, wherein data file or a part of such data file associated with the user ID is read out, and the personal information 14 is set.

Therefore, in the case of shopping at the outside, for example, the requester can set the personal information 14 by inputting the user ID, and can carry out evaluation due to simulation.

(Fourth Embodiment)

The present embodiment describes a commodity information providing system having personal information stored in the requester's device, the system being adopted to carry out the commodity information providing method for executing simulation at the provider's device.

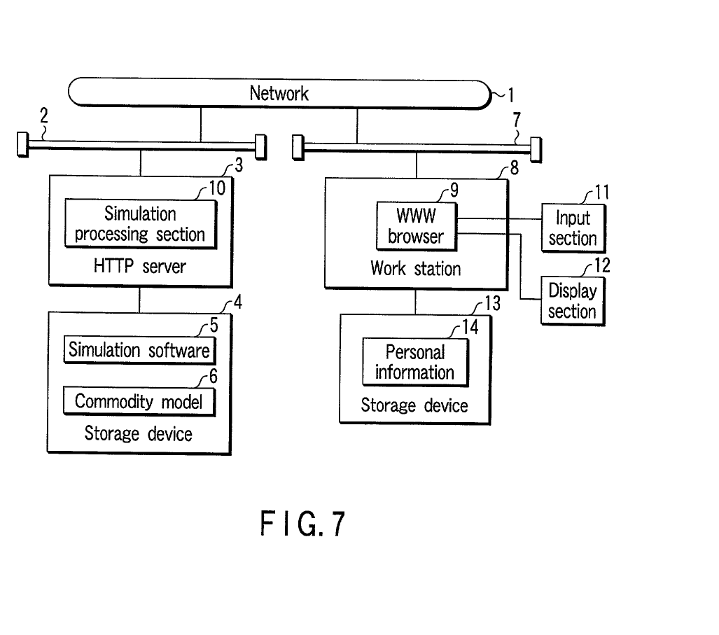

FIG. 7 is a block diagram illustrating a configuration of a commodity information providing system according to the present embodiment.

Although the simulation processing section 10 is included in the work station 8 in the first embodiment, the HTTP server 3 comprises the simulation processing section 10 in the fourth embodiment. Simulation is executed by the HTTP server 3. The other configuration is similar to that shown in FIG. 1. Thus, a description is omitted here.

When the work station 8 requests the HTTP server 3 to execute a simulation, the simulation processing section 10 of the HTTP server 3 read out the simulation software 5 and the corresponding commodity model 6 stored in the storage device 4, and requests the work station 8 for the personal information 14.

When the requester inputs a file name of the personal information 14 through the input section 11, the personal information 14 is read out from the storage device 13 of the work station 8, and the personal information 14 is transmitted to the HTTP server 3.

The simulation processing section 10 of the HTTP server 3 having received personal information 14 from the work station 8 initiates the simulation software 5. Then, simulation is executed based on the commodity model 6 read out from the storage device 4 and the personal information associated with a commodity selected by the requester from among items of the personal information 14 received from the work station 8, and the simulation result is transmitted to the work station 8.

The work station 8 outputs the received simulation result to the display section 12.

In addition, when the requester decides to purchase a commodity, the commodity to be purchased is added to property information included in items of the personal information 14 at the HTTP server 3. Then, the personal information 14 is transmitted from the HTTP server 3 to the work station 8, and the personal information is stored to be overwritten in the storage device 13 of the work station 8.

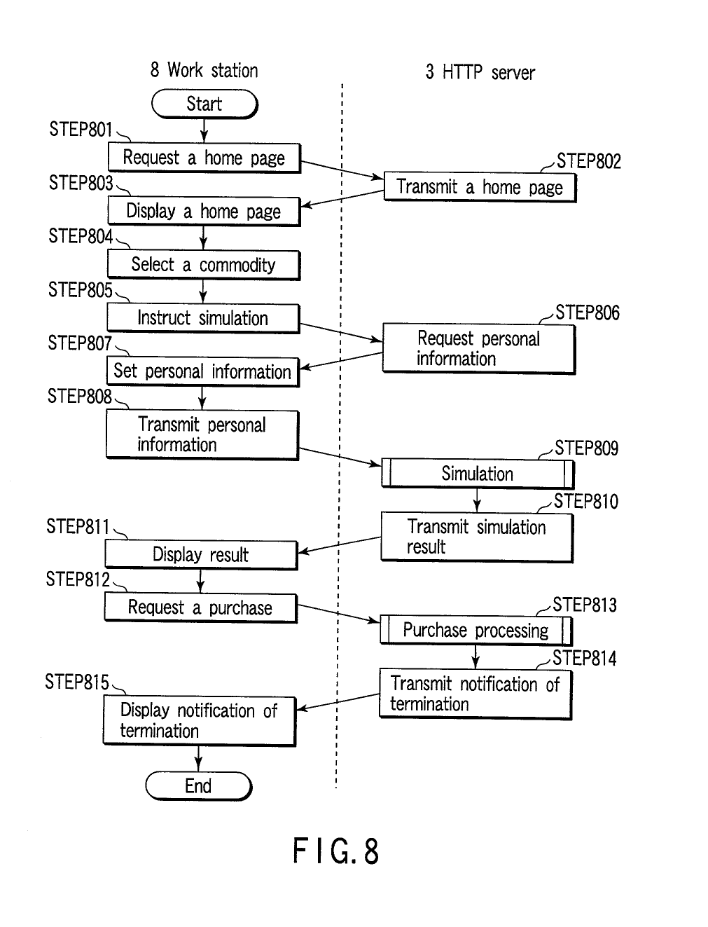

FIG. 8 is a flow chart illustrating procedures for operating the work station 8 and HTTP server 3 provided in the commodity information providing system according to the present embodiment.

Although procedures from purchase of one commodity to the end of purchase are shown here in order to describe transmission/receiving between the work station 8 and the HTTP server 3, in actuality, a commodity is selected on a home page again after the purchase procedures, and commodities can be continuously purchased.

First, in response to making a request for a home page of the work station 8 (STEP 801), a home page is transmitted from the HTTP server 3 to the work station 8 (STEP 802).

The work station 8 displays this home page at the display section 12 (STEP 803), and waits for input.

When a commodity on the home page is selected by the requester (STEP 804), and simulation is instructed (STEP 805), simulation is requested from the work station 8 to the HTTP server 3. Then, the simulation processing section 10 of the HTTP server 3 reads out the simulation software 5 and commodity model 6 stored in the storage device 4, and requests the work station 8 for the personal information 14 (STEP 806).

The work station 8 waits for input of the personal information 14 in accordance with a request from the HTTP server 3.

When a file name of the personal information 14 is inputted, a file containing the personal information 14 stored in the storage device 13 is opened. Then, the personal information 14 is read out, and the personal information 14 is set (STEP 807).

When the personal information 14 is set, the personal information 14 is transmitted to the HTTP server 3 (STEP 808).

The HTTP server 3 having received the personal information 14 executes simulation (STEP 809), and the simulation result is transmitted to the work station 8 (STEP 810).

The work station 8 having received the simulation result displays the result at the display section 12 (STEP 811).

When purchasing is instructed, the purchase process 3a is requested from the work station 8 to the HTTP server 3 (STEP 812). In addition, at the HTTP server 3, a commodity to be purchased is added to property information included in items of the personal information 14, the personal information 14 is transmitted from the HTTP server 3 to the work station 8, and the personal information 14 is stored to be overwritten in the storage device 13 of the work station 8. The HTTP server 3 carried out the purchase process 3a in response to the purchase process request from the work station 8 (STEP 813). When the purchase process 3a terminates, the notification of the termination is transmitted to the work station 8 (STEP 814). Then, the end of purchase procedures is displayed at the display section 12 of the work station 8 (STEP 815).

As has been described above, in the commodity information providing system according to the present embodiment, simulation is carried out by the simulation software 5 at the provider's device based on the selected personal information and the selected commodity model 6.

Therefore, the simulation software 5 and commodity model 6 may not be transmitted from the provider's device to the requester's device, and there can be solved a problem that a large amount of time is required for transmission of the simulation software 5 and commodity model 6. In addition, as has been described in the first embodiment, even if simulation is carried out by the provider's device, advantageous effect similar to that according to the first embodiment can be achieved.

(Fifth Embodiment)

The present embodiment describes a commodity information providing system having personal information stored in a smart card, the system being adopted to carry out a commodity information providing method for executing simulation by the requester's device.

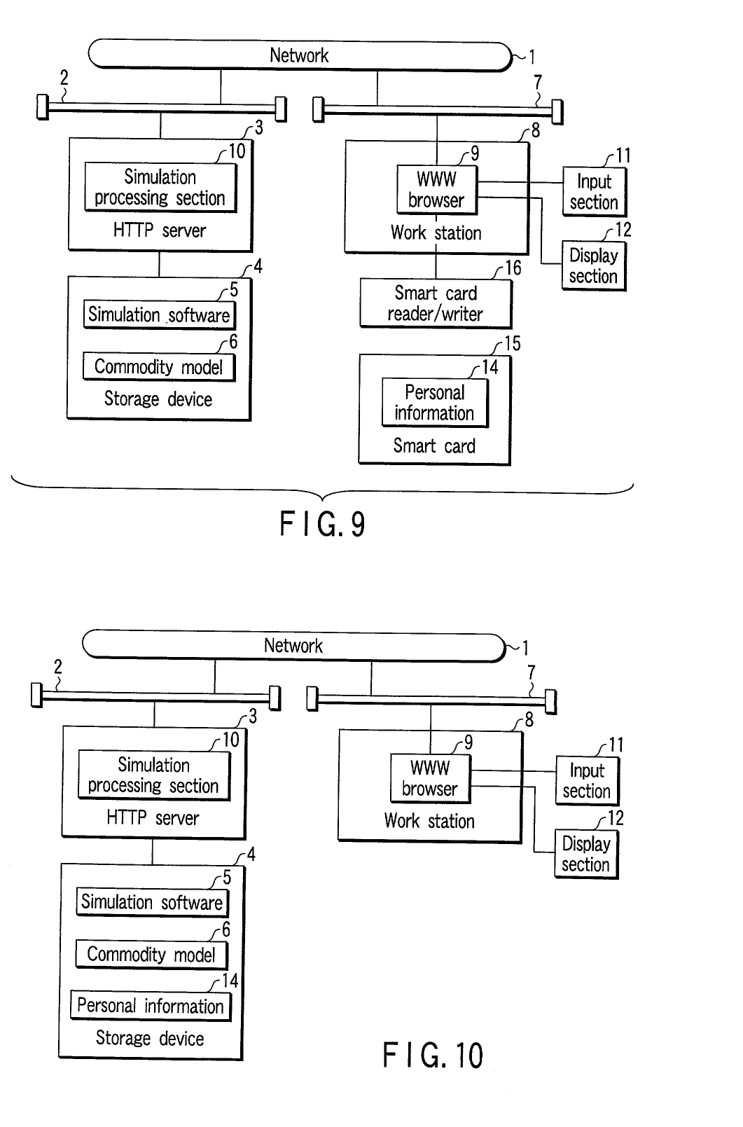

FIG. 9 is a block diagram illustrating a configuration of a commodity information providing system according to the present embodiment.

Although the personal information 14 is stored in the storage device 13 of the work station 8 in the fourth embodiment, the personal information 14 is stored in the smart card 15 in the fifth embodiment. In addition, the work station 8 equipped with the smart card reader/writer 16. The other configuration is similar to that shown in FIG. 7. Thus, a description is omitted here.

When the simulation processing section 10 of the HTTP server 3 requests the work station 8 for the personal information 14, the work station 8 waits for input of the personal information 14.

The start card 15 having the personal information 14 stored therein is inserted into the smart card reader/writer 16 equipped with the work station 8, the personal information 14 is read from the smart card 15, and the personal information 14 is transmitted to the HTTP server 3.

The simulation processing section 10 of the HTTP sever 3 having received the personal information from the work station 8 initiates the simulation software 5. Then, this section 10 executes simulation based on the commodity model 6 read from the storage device 4 and the personal information 14 transmitted from the work station 8, and transmits the simulation result to the work station 8.

The work station 8 outputs the received simulation result to the display section 12.

In addition, when the requester decides to purchase a commodity, the commodity to be purchased is added to property information included in items of the personal information 14 at the HTTP server 3. Then, new personal information 14 to which the commodity to be purchased in added is transmitted from the HTTP server 3 to the work station 8, and such new personal information 14 is stored to be overwritten in the smart card by means of the smart card reader/writer 16 of the work station 8.

In the present embodiment described above, although simulation is carried out at the provider's device, advantageous effect similar to those according to the second and fourth embodiments can be achieved.

(Sixth Embodiment)

The present embodiment describes a commodity information providing system having personal information stored in the provider's device, the system being adopted to carry out a commodity information providing method for executing simulation by the provider's device.

FIG. 10 is a block diagram illustrating a configuration of a commodity information providing system according to the present embodiment.

Although the personal information 14 is stored in the storage device 13 of the work station 8 in the fourth embodiment, the personal information 14 is stored in the storage device 4 of the HTTP server 3 in the sixth embodiment. The other configuration is similar to that shown in FIG. 7. Thus, a description is omitted here.

A user ID and a password are stored in advance to be associated with the personal information 14 in the storage device 4 of the HTTP server 3.

When the work station 8 requests the HTTP server 3 to start simulation, the simulation processing section 10 of the HTTP server 3 reads out the simulation software 5 and the commodity model 6 stored in the storage device 4, and requests the work station 8 for the user ID and password.

When the requester inputs the user ID and password through the input section 11, the user ID and password is transmitted to the HTTP server 3.

The HTTP server 3 having received the user ID compares the stored password with the received password. When these passwords are coincident, the personal information 14 associated with the user ID is read out from the storage device 4, and the personal information 14 is set.

When the personal information 14 is set, the simulation processing section 10 initiates the simulation software 5. Then, this section executes simulation based on the commodity model 6 read out from the storage device 4 and personal information associated with the specified commodity, and transmits the simulation result to the work station 8.

Then, the work station 8 outputs the received simulation result to the display section 12.

When the requester decides to purchase a commodity, the commodity to be purchased is added to property information included in items of the personal information 14 at the HTTP server 3, and new personal information 14 to which the commodity to be purchased is added is stored to be overwritten in the storage device 4.

In the present embodiment, all of the personal information 14 may not be stored at the provider's side, a part of the personal information 14 may be stored at the provider's side, and the other part may be stored at the requester's side.

In the present embodiment described above, although simulation is carried out by the provider's device, advantageous effect similar to those of the third and fourth embodiments can be achieved.

(Seventh Embodiment)

The present embodiment describes a modified example of each of the above described embodiments.

In each of the above described embodiments, a description will be given by exemplifying FIG. 3, for example, in which a simulation is instructed (STEP 205), and then, the personal information 14 is set (STEP 208).

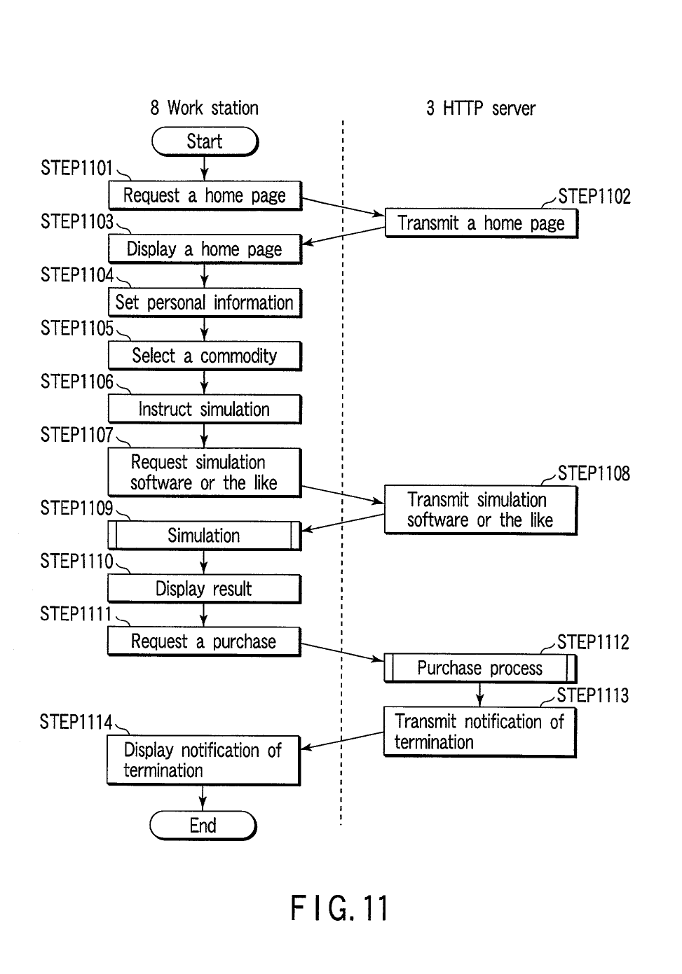

However, for example, as shown in FIG. 11, as in a case in which the personal information 14 is set (STEP 1104) before a commodity is selected (STEP 1105), similar advantageous effect can be variously changed within the scope in which similar advantageous effect can be achieved.

That is, the setting of the personal information 14 and selection of commodity may be carried out before actual simulation.

In addition, in each of the above described embodiments, although selection of commodity is specified by the requester, the commodity suitable to this requester may be automatically selected based on the requester's personal information 14.

For example, when the requester set the personal information 14, simulation is carried out by utilizing this personal information 14, and the commodity suitable to this requester is selected, whereby a recommended commodity is outputted to the requester.

In this manner, a commodity that is suitable to the requester's preference or that would be necessary for the requester is selected based on the requester's personal information 14. Further, from among them, information on a commodity whose size or performance is suitable to the requester is provided as information on recommended commodity by way of simulation.

Therefore, a chance for the requester to see a desired commodity can be increased.

Further, information on such recommended commodity may be notified to the requester via E-mail periodically or during sales campaign.

In this manner, a chance for the requester to see information on a commodity suitable to oneself can be increased, and a chance for the requester to make a contact with the provider can be increased.

In the commodity information providing system according to the first to seventh embodiments, the disposition of each constituent element may be changed as long as similar advantageous effect/functions can be achieved. In addition, the constituent elements each may be freely combined, and the sequence of processing to be executed may be replaced.

In addition, functions and elements each of the commodity information providing system according to the first to seventh embodiments are written into a recording medium such as a magnetic disk (such as a flexible disk or a hard disk), an optical disk (such as CD-ROM or DVD), or a semiconductor memory, for example, as computer executable programs, and are applicable to a computer or a computer system. Further, these functions and elements is applicable to a computer or a computer system by being transmitted via a communication medium.

In the above computer or computer system achieving the above functions each, a program recorded in a recording medium is read, and operation is controlled by the program, thereby executing the above described processing.

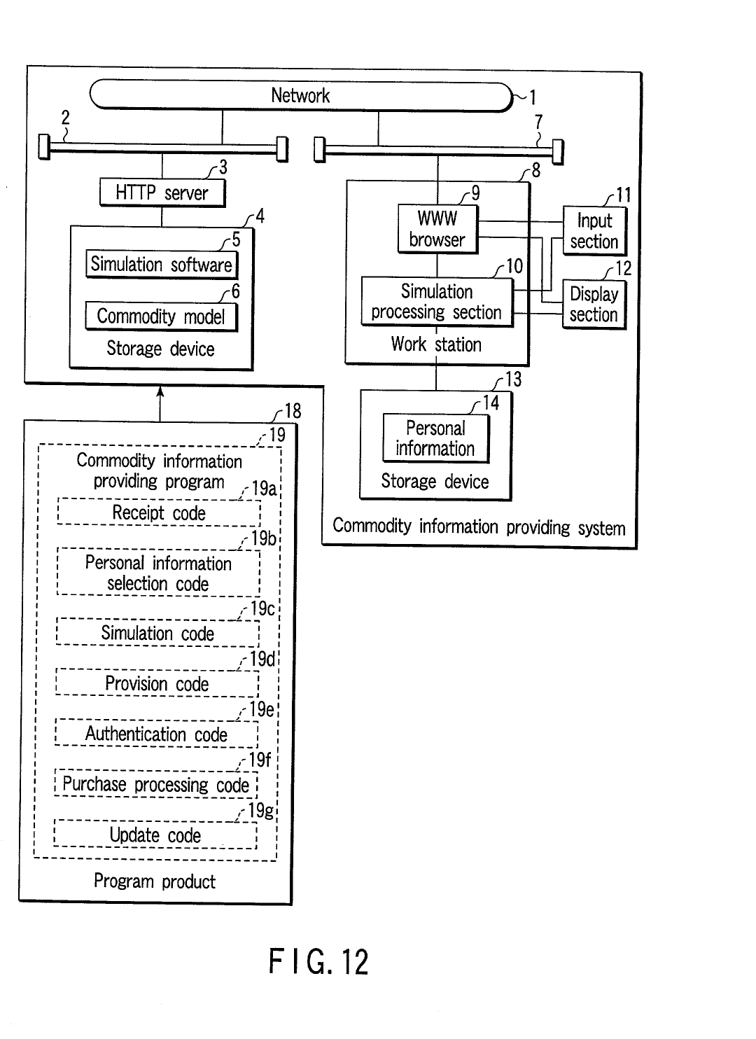

FIG. 12 is a block diagram illustrating a program product 18 having recorded therein a commodity information providing program 19 for achieving a function of the commodity information providing system according to the first embodiment over a computer.

The commodity information providing program 19 comprises a receipt program code 19a, a personal information selection code 19b, a simulation code 19c, a provision code 19d, an authentication code 19e, a purchase process code 19f, and an update code 19g.

The receipt code 19a receives information such as instruction for selecting a commodity from the requester, a request for making a change for the simulation result, or instruction for deciding to purchase a commodity.

The authentication code 19e carries out authentication by using the user identification information, and reads out only the requester's personal information included in items of the personal information 14.

The personal information selection code 19b selects only personal information associated with a commodity indicated by the selection instruction from among items of the requester's personal information.

The simulation code 19c carried out simulation based on commodity information on a commodity indicated by the selection instruction and selected personal information. In the case where a change request has been received, this code 19c carries out simulation again.

The provision code 19d provides the simulation result to the requester.

The purchase processing code 19f executes a commodity purchase process based on a purchase decision instruction.

The update code 19g updates the personal information 14 in the case the commodity is purchased.

The commodity information providing system according to the second to seventh embodiments as well is applicable to a computer in the form of a commodity information providing program.

(Eighth Embodiment)

The present embodiment describes a case where the present invention is applied to the purchase of an air conditioner over Internet.

The requester initiates the WWW browser 9 of the work station 8, makes connection with the HTTP server 3, and requests a home page.

Then, the home page is displayed at the display section 12 of the work station 8.

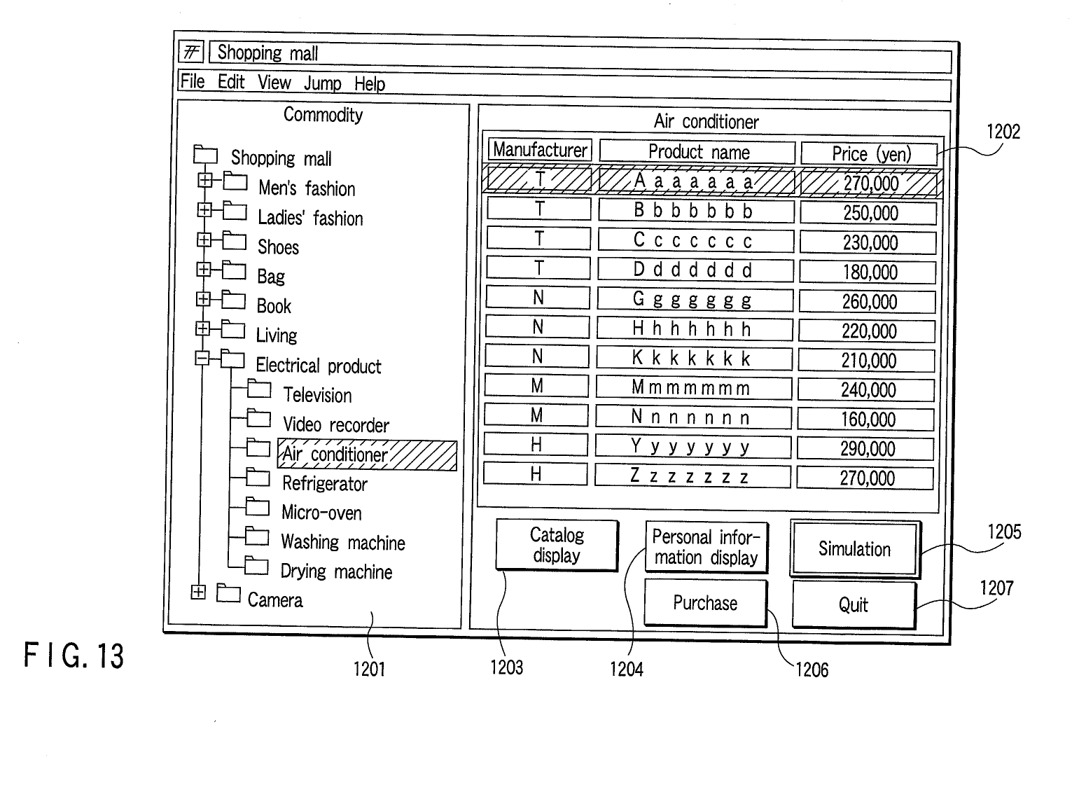

FIG. 13 is the home page.

The requester selects an air conditioner from among a commodity category list 1201 in the home page. Then, the air conditioners of manufacturers are respectively displayed on a commodity list 1202. The requester selects any product from the commodity list 1202, and clicks it. Then, the clicked product is highlighted. In FIG. 13, a product called Aaaaaaa of company T is selected. If a [catalog display] button 1203 is clicked in this state, catalog information on the product Aaaaaaa of company T is displayed.

In addition, If a [personal information setting] button 1204 is clicked, a dialog box for setting a file name of the personal information 14 is displayed. If the file name of the personal information 14 is inputted, the file of the personal information 14 stored in the storage device 13 of the work station 8 is read, and the personal information 14 is set.

The requester clicks a [simulation] button 1205, and instructs simulation. Then, the simulation software 5 and air conditioner model of the HTTP server 3 is requested from the work station 8, and the simulation software 5 and air conditioner model are transmitted from the HTTP server 3 to the work station 8. Then, a simulation window is displayed.

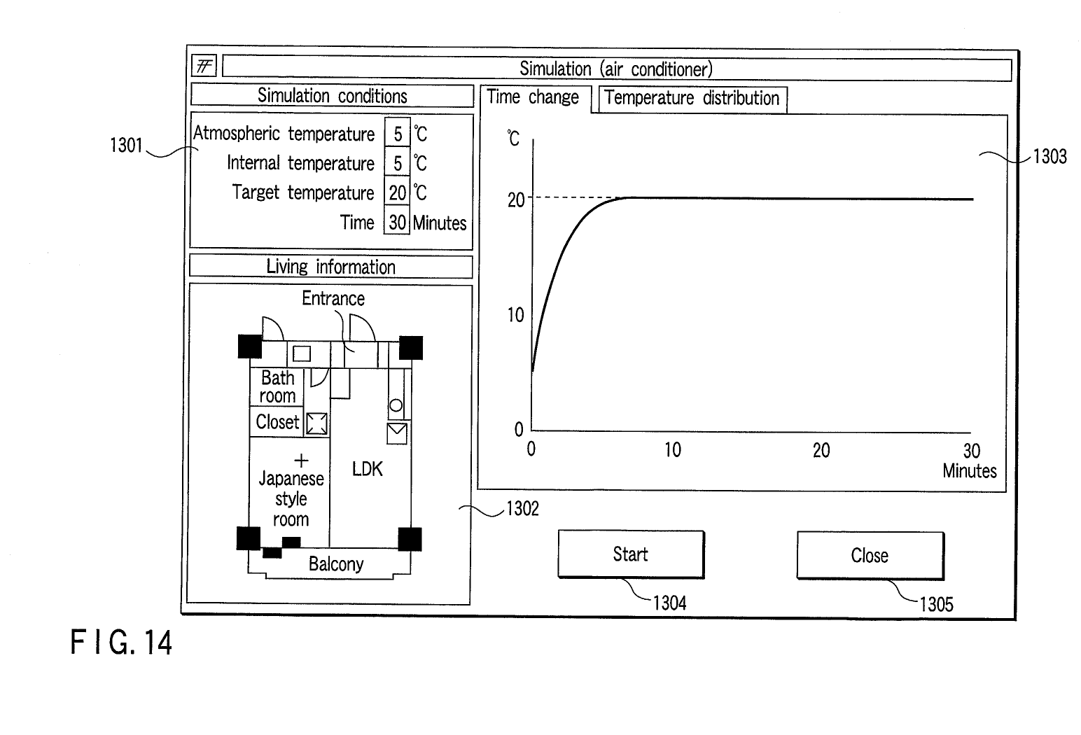

FIG. 14 is a first view of the simulation window.

The simulation window differs depending on type of the selected commodity. In this example showing a case of air conditioner, the simulation window is composed of a simulation condition section 1301, a living information section 1302, and a simulation result section 1303.

The requester first sets an atmospheric temperature of the simulation condition section 1301, an initial temperature (internal temperature) inside room, a target temperature, and a simulation time. In FIG. 14, the atmospheric temperature is set to 5° C., the internal temperature is set to 5° C., the target temperature is set to 20° C., and the simulation time is set to 30 minutes. At the simulation condition section 1301, an air conditioner operation mode may be set.

Next, the requester places an interior model of an air conditioner in a room inside of a house in the layout of the housing displayed at the living information section 1302, and places an exterior model of the air conditioner in a place outside of the house. The layout of the housing displayed at the living information section 1302 is displayed based on information read from the personal information 14. In FIG. 14, although the layout of the housing is represented in a plan view, the layout is represented in a three-dimensional manner so that the height of the setup position of the air conditioner may be specifiable. In FIG. 14, an interior air conditioner is placed in Japanese style room, and an exterior air conditioner is placed in balcony.

Next, the requester clicks the [start] button 1304. Then, simulation is started, and the simulation result is displayed at the simulation result section 1303. At this time, simulation is carried out in consideration of conditions obtained from the personal information 14 such as room layout, an occupying rate of materials placed, a heat insulation effect of the room, a setup position of the air conditioner and a temperature and a wind speed of a wind that blows from a blowout opening of the air conditioner.

This simulation is achieved by expressing physical phenomena such as heat conduction, the flow of fluids as a differential equation, and solving it by numeric solution such as finite element approach. These techniques are described in literature such as “Numeric Analysis of Heat Transition and Flow by Computer”, authored by Shath V. Patanker and jointly translated by Yukio Mizutani and Shoji Kozuki (Morikita Shuppaan) or the like. In addition, a variety of fluid analysis approaches are available. In this way, a variety of well known techniques are available for use in simulation of the present embodiment.

The simulation result is displayed at the simulation result section 1303. In FIG. 14, the simulation result section 1303 include two pages [Time Change] and [Temperature Distribution]. When a tab is clicked, the clicked page is displayed in front of the screen.

In FIG. 14, a page [Time Change] is displayed in front of the screen. A cross mark (+) in Japanese style room included in living information represents a temperature measuring position, and a temperature time change graph at a three-dimensional position of one height at this position is displayed on the page [Time Change]. The horizontal axis represents a time that ranges from 0 to 30 minutes after the air conditioner has been powered ON, and the vertical axis represents a temperature. In this graph, the temperature reaches 20° C. about 6 minutes after the switch has been turned ON.

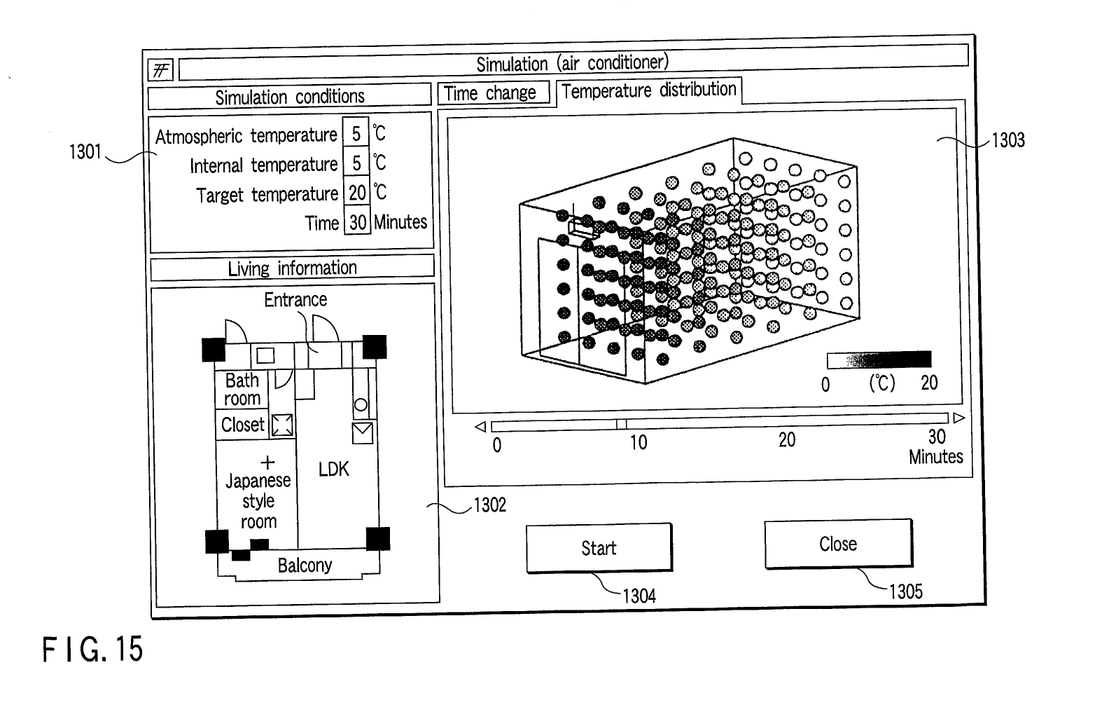

FIG. 15 is a second view of a simulation window, where the page [Temperature Distribution] is displayed in front of the simulation result section 1303. When the [start] button 1304 is clicked, simulation is started. Then, a time after the air conditioner has been switched ON and the internal temperature distribution is displayed in a three-dimensional manner.

From this simulation result, it is possible to know a time required to reach the target temperature and an internal temperature distribution. In the case where the performance is insufficient, the model is changed, and simulation can be newly executed. In the case where the internal temperature is non-uniform, the interior machine setup place is changed, and simulation can be retried. The requester can decide to purchase a commodity after the commodity has been thoroughly evaluated.

In the case of purchasing the commodity, a [close] button 1305 on a simulation window is clicked, thereby closing the simulation window. Next, a [purchase] button 1206 on a home page (FIG. 13) is clicked. Then, procedures for purchasing the selected air conditioner are carried out.

When the requester clicks a [quit] button 1207, connection with the HTTP server 3 is cut out, and shopping terminates.

In this example, although simulation has been executed at the work station 8, such simulation may be executed at the HTTP server 3. In that case, when a [personal information setting] button 1204 on a home page is clicked, a dialog box for setting a file name of the personal information 14 is displayed. When the requester inputs a file name of the personal information 14, the file of the personal information 14 stored in the storage device 13 of the work station 8 is read out, and is transmitted to the HTTP server 3. When the requester clicks a [simulation] button 1205, and instructs simulation, the instruction is transmitted from the work station 8 to the HTTP server 3. Then, the simulation software 5 and commodity model 6 are read out from the storage device 4 of the HTTP server 3.

Then, a simulation window is displayed at the display section 12 of the work station 8. When the requester decides a simulation condition and an air conditioner setup place, and clicks a [start] button 1304, information on the simulation condition and air condition setup place is transmitted to the HTTP server 3. Then, simulation based on the simulation condition and air conditioner setup place is started at the HTTP server 3. The simulation result is transmitted from the HTTP server 3 to the work station 8, and is displayed at the simulation result section 1303 of the simulation window.

(Ninth Embodiment)

The present embodiment describes a case where an air conditioner is purchased in accordance with the eighth embodiment, and then, a shirt is purchased continuously over internet.

When a [purchase] button 1206 on the home page shown in FIG. 13 is clicked, the procedures for purchasing the air conditioner terminates.

The requester selects a shirt from a commodity category list 1201 in the home page, and selects a manufacturer from its sub-list. Then, the shirts of the selected manufacture are displayed on a commodity list 1202.

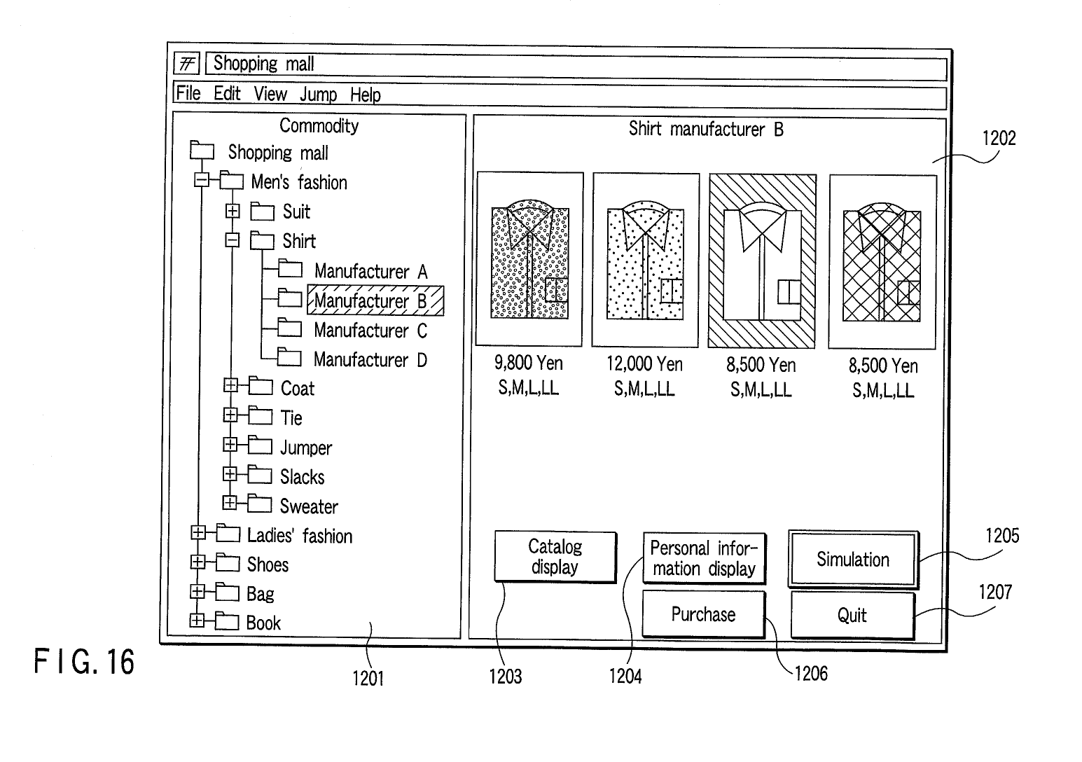

FIG. 16 is a view of a home page. In FIG. 16, a shirt manufacturer B is selected, and the shirts of the manufacturer B are displayed in the commodity list 1202. When the requester clicks any of the displayed shirts, the clicked shirt is highlighted.

In FIG. 16, a second plain shirt is selected from the right. In this state, when the requester clicks a [catalog display] button 1203, catalog information such as material and design is displayed relevant to the selected shirt.

The personal information 14 may not be set again because the corresponding file name is set during purchase of the air conditioner. However, the contents of personal information utilized during simulation differ depending on commodity type. Thus, when information required for simulation is not set, the file of the personal information 14 is read out again, and the required information contained in items of the personal information 14 is set.

On the other hand, when the file of the personal information 14 is first read, the contents of the personal information 14 are stored in a memory. In the case where required information is not set during simulation, required data is copied from the memory, and is set.

In the case where the commodity is shirt, body information is set from among items of the personal information 14. The body information is defined as information indicating body characteristics. This information generally includes neck line, check line, waist line or arm line and the like. The body information used here also includes sectional periphery length of predetermined intervals of the body (for example, intervals of 1 cm).

The requester clicks a [simulation] button 1205, and instructs simulation. Then, the simulation software 5 and shirt model are transmitted to the work station 8, and the simulation window is displayed. The shirt model includes the length of periphery obtained by slicing a sleeve line, a waist line, an arm line with predetermined intervals.

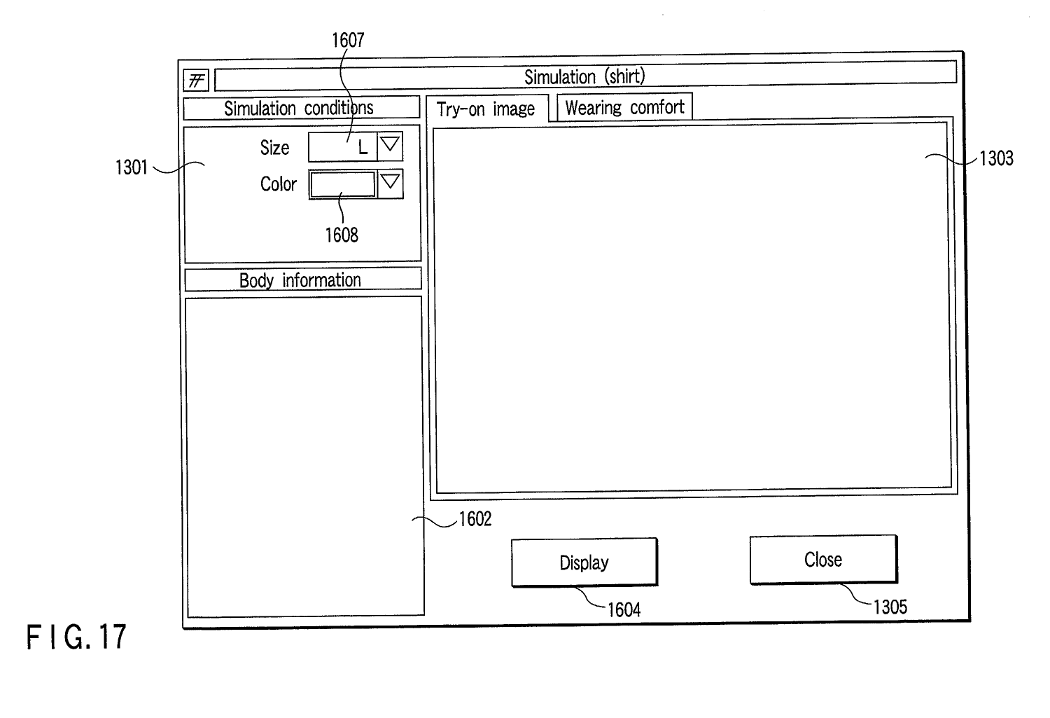

FIG. 17 is a view of a simulation window. The simulation window differs depending on the type of the selected commodity. In this example showing a case of shirt, this window is composed of a simulation condition section 1301, a body information section 1602, and a simulation result section 1303. The simulation condition section 1301 has a [size] combo box 1607 and a [color] combo box 1608. If a commodity is identical to the selected shirt in design and is different in size or color, such commodity is displayed in a list of the combo box. For example, in the case where M is selected from size list, if there is a shirt with size M and different color, such color is displayed in a list of the [color] combo box 1608. Then, simulation is carried out for the shirt set at these combo boxes 1607 and 1608.

As a method for switching the color and size, there is provided a method in which shirt models each having the size and color combined is included in shirt models transmitted from the HTTP server 3, and simulation is carried out by using a shirt model that conforms to a condition for the size and color selected by the [size] combo box 1607 and [color] combo box 1608.

In addition, another method for switching the color and size, there is provided a method in which, after a typical size and color shirt model has been first transmitted from the HTTP server 3 to the work station 8, when the size and color are selected at the [size] combo box 1607 and [color] combo box 1608, the work station 8 requests the HTTP server 3 for a shirt model that conforms to such condition, and the work station 8 carries out simulation by using the shirt model transmitted from the HTTP server 3 in response to such a request.

According to such a method, the specification such as commodity size and color is changed on the simulation window, and simulation can be executed.

The body characteristics such as a neck line, a chest line, a shoulder width, or an arm length are displayed at a body information section 1602. The simulation result section 1303 has two pages [try-on image] and [wearing conform]. When the requester clicks a tab, the selected page is displayed in front of the screen.

On the page [try-on image], a three-dimensional image when the requester wears a selected shirt is displayed, where image rotation or expansion/reduction can be carried out.

On the page [wearing comfort], a body image when the requester wears a shirt is displayed, where a just fit portion, a loose portion, and a tight portion in the shirt are displayed with colorings. Specifically, by using body three-dimensional information and shirt model, for example, the length of periphery and the corresponding portion of the shirt are compared with each other by slicing the belly, arm, and neck of the requester with predetermined intervals, for example. Then, with respect to each portion, the just fit portion is displayed by coloring it when the shirt is larger and within a predetermined margin range; the loose portion is displayed by coloring it if the shirt is larger than such margin range; and the tight portion is displayed by coloring it if the shirt is smaller than the margin range.

The requester first selects the size and color of the simulation condition section 1301. In FIG. 17, a size L and a white color is selected.

Next, the requester clicks a [view] button 1604. Then, simulation is started, and the simulation result is displayed at the simulation result section 1303. From this simulation result, the requester can evaluate whether or not the shirt is suitable to oneself.

As the result of simulation, in the case where an attempt is made to change the shirt size or color, for example, if an attempt is made to increase the size because the neck line is tight, the settings of the [size] combo box 1607 and [color] combo box 1608 of the simulation condition section 1301 are changed, and the [view] button 1604 is clicked again. In this manner, a simulation having the size or color changed is executed, and the result can be displayed at the simulation result section 1303.

As the result of simulation, in the case where the requester finds a proper shirt, and purchases it, the requester clicks a [close] button 1305 on the simulation window, and closes the simulation window.

Next, when the requester clicks a [purchase] button 1206 on the home page (FIG. 16), procedures for purchasing the selected shirt is carried out. At this time, information on a shirt that the requester decides to purchase is added to property information included in items of the personal information 14, and new personal information 14 is stored to be overwritten in the storage device 13 of the work station 8.

In the case where an attempt is made to continuously see another commodity, when a commodity category is selected from a commodity category list 1201, a commodity included in such commodity category is displayed in a commodity list 1202.

On the other hand, in order to terminate shopping, the requester clicks a [quit] button 1207, connection with the HTTP server 3 is cut out, and shopping is terminated.

(Tenth Embodiment)

The present embodiment describes a case where a shirt is purchased over Internet as in the ninth embodiment, and personal information is stored in the provider's device.

The requester's personal information 14 is stored in advance in the storage device 4 of the HTTP server 3 while the user ID and password are associated with each other.

The requester initiates the WWW browser 9 of the work station 8, makes connection with the HTTP server 3, and requests a home page. Then, the home page is displayed at the display section 12 of the work station 8.

Next, the requester clicks a [personal information setting] button. Then, a [user ID and password input] dialog box is displayed at the display section 12 of the work station 8.

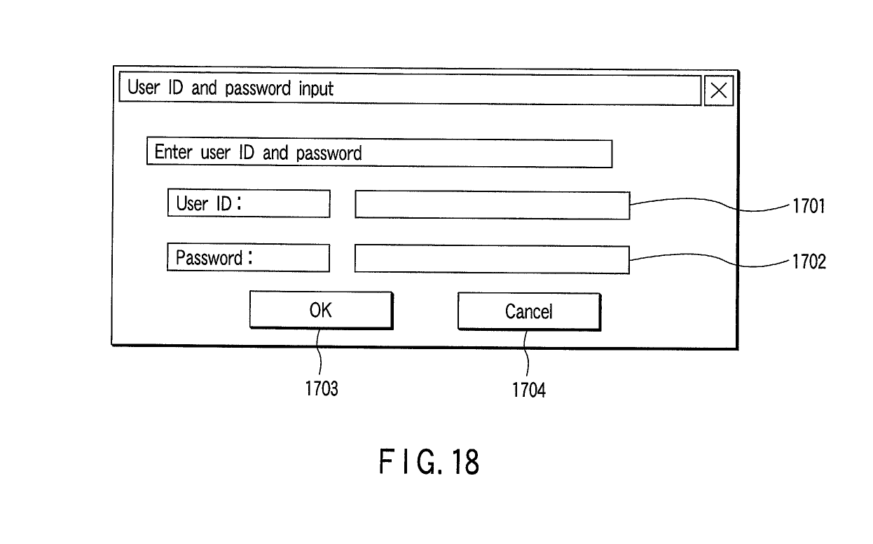

FIG. 18 shows an example of the [user ID and password input] dialog box.

The requester inputs a user ID in a [user ID] edit box 1701 within the [user ID and password input] dialog box, inputs a password in a [password] edit box 1702, and clicks an [OK] button 1703. Then, the [user ID and password input] dialog box is closed, and the inputted user ID and password are transmitted to the HTTP server 3.

The HTTP server 3 compares a password associated with the received user ID with the received password. If these passwords are coincident, the personal information 14 associated with the user ID is read out from the storage device 4. Then, the personal information 14 is transmitted to the work station 8, and the personal information 14 is set.

In addition, at this time, at the HTTP server 3, simulation is carried out by utilizing the read personal information 14. For example, a commodity suitable to the requester is selected from among new products, and the selected commodity is displayed on a home page.

For example, with respect to clothes, commodities are narrowed based on the gender, age, purchase history of the requester written in the personal information 14. From among these commodities, a commodity suitable to the requester is selected by way of simulation using body information, and the selected commodity is displayed on home page.

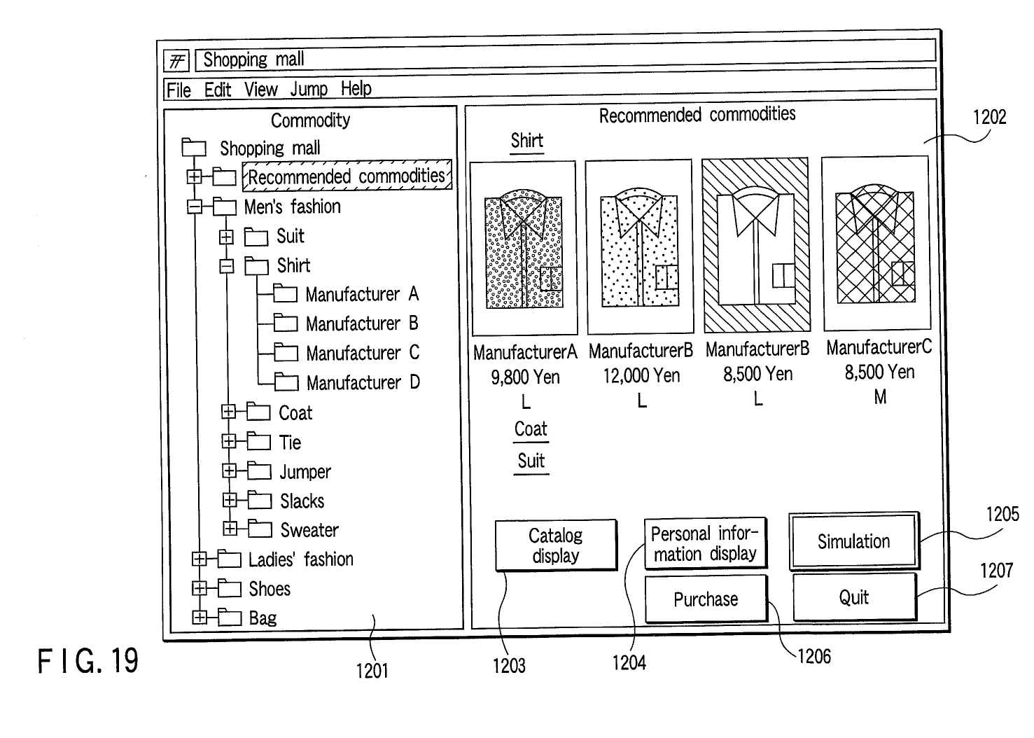

FIG. 19 shows an example of such home page. A commodity category list 1201 includes an item called recommended commodities, and the selected commodity is displayed. The recommended commodities are displayed in the commodity list 1202.

The requester can easily select a commodity suitable to oneself from the above commodity list. When the requester clicks one of the displayed commodities, such commodity is highlighted.

In FIG. 19, the second right plain shirt is selected. The requester clicks a [simulation] button 1205, and instructs simulation. Than, the simulation software 5 and shirt model are transmitted from the HTTP server 3 to the work station 8, and the simulation window is displayed. A description of the subsequent operating procedures is omitted here because the procedures are identical to those according to the ninth embodiment.

In addition, the requester can select a commodity that is not included in recommended commodities. As in the ninth embodiment, the requester selects a category of the desired commodity from the commodity category list 1201, thereby making it possible to select one commodity from among the commodities displayed in the commodity list 1202.

In this example, although the simulation processing section 10 is present at the work station 8, and simulation is executed at the work station 8, the simulation processing section 10 may be present at the HTTP server 3, and simulation may be executed at the HTTP server 3. In this case, the personal information 14 read out at the HTTP server 3, the simulation software 5, and the commodity model 6 are not transmitted to the work station 8, and simulation is executed at the HTTP server 3. Then, the simulation result is transmitted from the HTTP server 3 to the work station 8, and the transmitted simulation result is displayed at the display section 12 of the work station 8.

(Eleventh Embodiment)

The present embodiment describes a case where a shut is purchased over Internet as in the ninth embodiment, and the requester inputs an informational numeric value instead of reading out the personal information 14 from a file.

The requester initiates the WWW browser 9 of the work station 8, makes connection with the HTTP server 3, and requests a home page. Then, the home page is displayed at the display section 12 of the work station 8.

The requester selects a shirt from the commodity category list 1201 in the home page, and selects a manufacturer from its sub-list. Then, the shirts of the selected manufacturer are displayed in the commodity list 1202.

When the requester selects any of the displayed shirts, such selected shirt is highlighted. The requester clicks the [simulation] button 1205, and instructs simulation. Then, the simulation software 5 and shirt model are transmitted to the work station 8, and the simulation window is displayed.

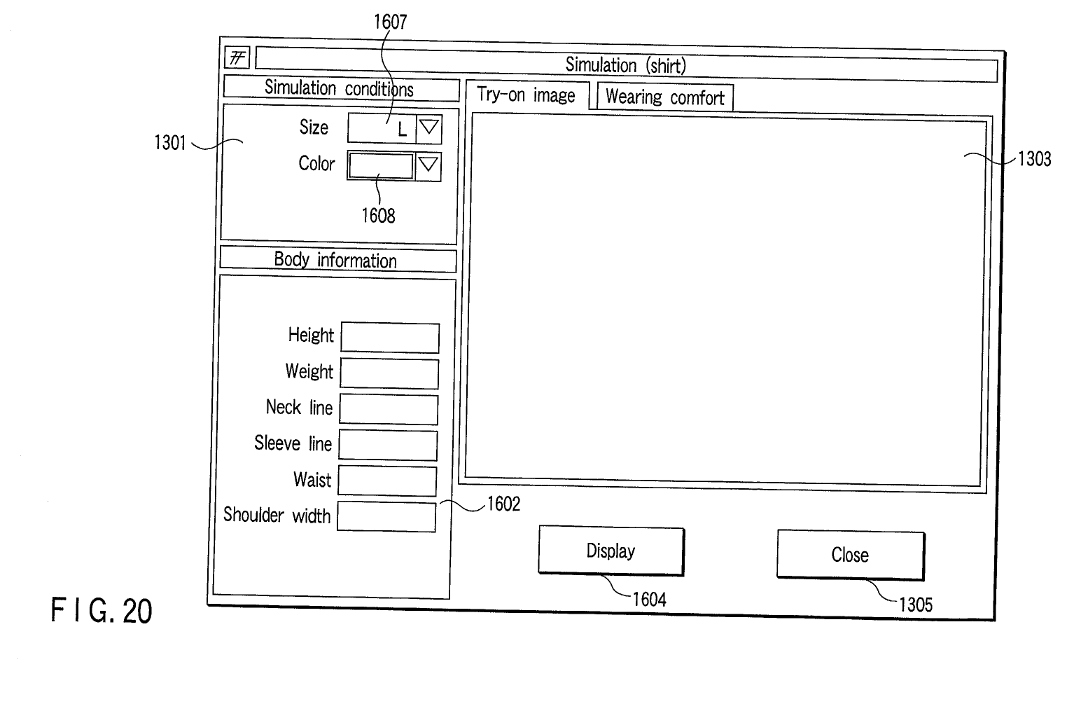

FIG. 20 is a view of the simulation window. In this example, the simulation window comprises a simulation condition section 1301, a body information section 1602, and a simulation result section 1303.

Thee simulation condition section 1301 comprises a [size] combo box 1607 and a [color] combo box 1608. If a commodity is identical to the selected shirt in design, and is different in size or color, a variation of sizes and colors is displayed in a list of the combo box. For example, when M is selected from the size list, if a shirt of size M and of different color is present, such color is displayed in a list of the [color] combo box 1608. Then, simulation is carried out for the shirt set in the combo box.

At the body information section 1602, edit boxes such as [height], [weight], [neck line], [chest line], [shoulder width], and [arm length] are disposed. The requester can input body information directly to these edit boxes.

The simulation result section 1303 has two pages [try-on image] and [wearing comfort]. When a tab is clicked, the corresponding page is displayed in front of the screen. A description of these pages is omitted because the description is identical to that according to the ninth embodiment.

The requester first sets the size and color of the simulation condition section 1301. In FIG. 20, a size L and a white color are selected.

Next, body information such as height, weight, neck line, chest line, shoulder width, arm length, at the body information section 1602, is set, and a [view] button 1604 is clicked. Then, simulation is started by utilizing a three-dimensional body model having body information set at the body information section 1602, and the simulation result is displayed at the simulation result section 1303.

From this simulation result, the requester can evaluate whether a shirt is suitable to oneself.

(Twelfth Embodiment)

The present embodiment described a case where a commodity is selected from E-mail for delivered recommended commodities, and is purchased. The requester's personal information 14 is stored in advance in the storage device 4 of the HTTP server 3 while the user ID and password are associated with each other. The HTTP server 3 reads out the requester's personal information 14, the commodity model 6 on each new commodity, and the simulation software 5 periodically from the storage device 4, and executes simulation for such each new commodity.

Then, the degrees suitable to the requester are numerically represented for such each new commodity, and some of the commodities at the upper class are defined as recommended commodities.

E-mail having a home page that lists such recommended commodities stored in a attached file is delivered to the requester.

When the requester opens the attached file of the received E-mail, the home page listing recommended commodities is displayed. An example of this home page is shown in FIG. 19.

The requester can select a commodity from the list of recommended commodities, and can carry out simulation or purchase procedures. A description of such selection and simulation is omitted here because the description is identical to that according to the tenth embodiment. Although the present embodiment shows an example when simulation is carried out for a new commodity periodically, and E-mail is delivered, for example, such simulation may be carried out for an item for sales during sales campaign, and E-mail may be delivered.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of providing commodity information to a commodity information requester via a network, comprising:
receiving a commodity selection instruction from the requester via the network;
selecting an item or items which are associated with the commodity selected by the requester from among items of personal information of the requester that have been collected in advance;
generating requester specific commodity information based on commodity information on the selected commodity and the selected item or items of the personal information; and
providing the generated requester specific commodity information to the requester.

2. The commodity information providing method according to claim 1, further comprising receiving change request information from the requester to the requester specific commodity information; changing the requester specific commodity information based on the change request information, and providing the changed requester specific commodity information to the requester.

3. The commodity information providing method according to claim 1, wherein the personal information is recorded in a recording medium held by the requester, and is utilized after read out from the recording medium.

4. The commodity information providing method according to claim 1, wherein the personal information is recorded in a recording medium owned by a commodity information provider, and is utilized after read out from the recording medium.

5. The commodity information providing method according to claim 1, wherein authentication is carried out by using user identification information, and only the requester's personal information is utilized.

6. The commodity information providing method according to claim 1, wherein a decision of purchasing the selected commodity is received from the requester.

7. The commodity information providing method according to claim 6, wherein the personal information is updated based on the decision of purchasing the commodity.

8. A method of providing commodity information to a commodity information requester via a network, comprising:
generating requester specific commodity information indicating a commodity or commodities related to the requester based on personal information of the requester that has been collected in advance; and
providing the requester specific commodity information to the requester via the network.

9. The commodity information providing method according to claim 8, wherein the personal information is recorded in a recording medium held by the requester, and is utilized after read out from the recording medium.

10. The commodity information providing method according to claim 8, wherein the personal information is recorded in a recording medium owned by a commodity information provider, and is utilized after read out from the recording medium.

11. The commodity information providing method according to claim 8, wherein authentication is carried out by using user identification information, and only the requester's personal information is utilized.

12. The commodity information providing method according to claim 8, wherein a decision of purchasing the commodity is received from the requester.

13. The commodity information providing method according to claim 12, wherein the personal information is updated based on the decision of purchasing the commodity.

14. A commodity information providing system for providing commodity information to a commodity information requester, the system comprising:
an input section that inputs an instruction for selecting a commodity from the requester;
a personal information selecting section that selects an item or items which are associated with the commodity selected by the requester from among items of personal information of the requester that have been collected in advance;
a simulation section that generates requester specific commodity information based on commodity information on the commodity indicated by a selection instruction inputted by the input section and the selected item or items of the personal information; and
an output section that outputs to the requester the requester specific commodity information generated by the simulation section.

15. The commodity information providing system according to claim 14, wherein the input section inputs, from the requester, change request information relevant to the requester specific commodity information generated by the simulation section, the simulation section changes the requester specific commodity information based on the change request information, and the output section outputs to the requester the changed requester specific commodity information.

16. The commodity information providing system according to claim 14, further comprising there is provided an authentication section that carries out authentication by using user identification information and for reads out only the requester's personal information.

17. The commodity information providing system according to claim 14, wherein the input section inputs an instruction for deciding to purchase the commodity selected from the requester, and the commodity information providing system further comprises a purchase processing section that executes commodity purchase processing based on the instruction for deciding to purchase the commodity inputted by the input section.

18. The commodity information providing system according to claim 17, further comprising an update section that updates the personal information based on a purchase decision instruction.

19. A commodity information providing system for providing commodity information to a commodity information requester, said system comprising:
a commodity information selection section that generates requester specific commodity information indicating a commodity or commodities related to the requester based on personal information of the requester that has been collected in advance; and
an output section that outputs to the requester the requester specific commodity information.

20. The commodity information providing system according to claim 19, further comprising an authentication section that carries out authentication by using user identification information, and reads out only personal information of the requester.

21. The commodity information providing system according to claim 19, wherein the input section inputs an instruction for deciding to purchase the commodity from the requester, and the commodity information providing system further comprises a purchase processing section that executes commodity purchase processing based on the instruction for deciding to purchase the commodity inputted by the input section.

22. The commodity information providing system according to claim 21, further comprising an update section that updates the personal information based on the decision for determining the purchase of the commodity inputted by the input section.

23. An article of manufacture comprising a computer usable medium having computer readable program code means embodied therein, the computer program code means comprising:
a receipt computer readable program code means for causing a computer to receive an instruction for selecting a commodity from the requester;
a personal information selection computer readable program code means for causing the computer to select an item or items which are associated with the commodity selected by the requester from among items of personal information of the requester that have been collected in advance;
a simulation computer readable program code means for causing the computer to generate requester specific commodity information based on commodity information on the selected commodity and the selected item or items of the personal information; and
a provision computer readable program code means for causing the computer to provide the requester specific commodity information to the requester.

24. The computer program product according to claim 23, wherein said receipt computer program code means comprises program code means to receive change request information relevant to the requester specific commodity information; the simulation computer program code means comprises program code means to change the requester specific commodity information based on the change request information; and the provision computer program code means comprises program code means to provide the changed requester specific commodity information to the requester.

25. The computer program product according to claim 23, further comprising an authentication computer readable program code means for causing the computer to carry out authentication by using user identification information, and reads out only the requester's personal information.

26. the computer program product according to claim 23, wherein said receipt computer program code means comprises program code means to receive from the requester an instruction for deciding to purchase the commodity selected, and comprises a purchase processing computer readable program code means for causing the computer to execute commodity purchase processing based on the purchase decision instruction.

27. The computer program product according to claim 26, further comprising an update computer readable program code means for causing the computer to update the personal information based on the purchase decision instruction.

28. An article of manufacture comprising a computer usable medium having computer readable program code means embodied therein, the computer program code means comprising:
a commodity information selection computer readable program code means for causing a computer to generate requester specific commodity information indicating a commodity or commodities related to the requester based on personal information of the requester that has been collected in advance; and
a provision computer readable program code means for causing the computer to provide the requester specific commodity information to the requester.

29. The computer program product according to claim 28, further comprising an authentication computer readable program code means for causing the computer to carry out authentication by using user identification information, and reads out only the requester's personal information.

30. The computer program product according to claim 28, further comprising a receipt computer readable program code means for causing the computer to receive from the requester an instruction for deciding to purchase the commodity, and comprises a purchase processing computer readable program code means for causing the computer to execute commodity purchase processing based on the purchase decision instruction.

31. The computer program product according to claim 30, further comprising an update computer readable program code means for causing the computer to update the personal information based on the purchase decision instruction.
